(19) United States
(12) Patent Application Publication
(10) Pub. No.: US 2002/0078242 A1
(43) Pub. Date: Jun. 20, 2002

(54) Method of selectively compressing data packets

(76) Inventor: Nanjundiah Viswanath, Fremont, CA (US)

Correspondence Address: Charles K. Young, BLAKELY, SOKOLOFF, TAYLOR & ZAFMAN LLP, 12400 Wilshire Boulevard 7th Floor, Los Angeles, CA, 90025, US

(21) Appl. No.: 09/738,813

(22) Filed: Dec. 15, 2000

(51) Int. Cl. G06F 15/16

(52) U.S. Cl. 709/247

(57) ABSTRACT

A method of selectively compressing data packets is achieved by bypassing a compression process responsive to detecting a first marker in the data packets. The compression process is resumed responsive to detecting a second marker in the data packets.

### BACKGROUND OF THE INVENTION

1. Field of the Invention

The described invention relates to the compression of network data packets.

2. Description of Related Art

In network communications, data is typically compressed to speed up communications over connections having a low bandwidth. However, compression of data takes up resources and time. If one tries to compress data that is already compressed, the compression typically fails, and a larger data item than the original often results.

FIG. 1 shows a prior art example of a virtual private network that allows two gateways 10 and 20 to talk to each other over the Internet 30. The communications are encrypted so that any unauthorized interception of data over the public Internet will not be decipherable.

Multiple computers 11-14 are connected to the first gateway 10 and multiple computers 21-23 are connected to the second gateway 20. The gateways 10 and 20 communicate with each other by sending data packets. The data packets are compressed and encrypted on one gateway then sent over the Internet 30 to the other gateway which decrypts the data packets and decompresses them.

IPsec (latest revision, RFC 2401, November 1998), an industry specification published by the Internet Engineering Task Force, provides security at the Internet Protocol level. Compression is performed before encryption of data packets. Compression avoids fragmentation of data and increases throughput. When compression is successful (i.e., it reduces a data packet's size), a new header is added to the data packet. This header is used by the decoding side to apply the correct decompression algorithm after the decryption process. More information on IPsec can be found on its web site www.ietf.com.

Usually two peers negotiate via an Internet Key Exchange (“IKE”) process whether to use compression or not. When the type of traffic is primarily text data, compression is turned on. When the traffic is primarily compressed, e.g., compressed video only, compression is turned off since there is no need to do compression (it is already compressed). However, for a mixture of compressed data and uncompressed data (e.g., text data) such as in a web page, the decision whether to compress is not clear.

One way of addressing the problem is a heuristic approach in which data packets are sampled periodically. If the current data packet is compressed, then compression is turned off for a certain period of time. Subsequent data packets are sampled, and when the data packets are no longer compressed, then compression is turned off. However, such tests for compression take time and resources.

### BRIEF DESCRIPTION OF THE DRAWINGS

FIG. 1 shows a prior art example of a virtual private network that allows two gateways to talk to each other over the Internet.

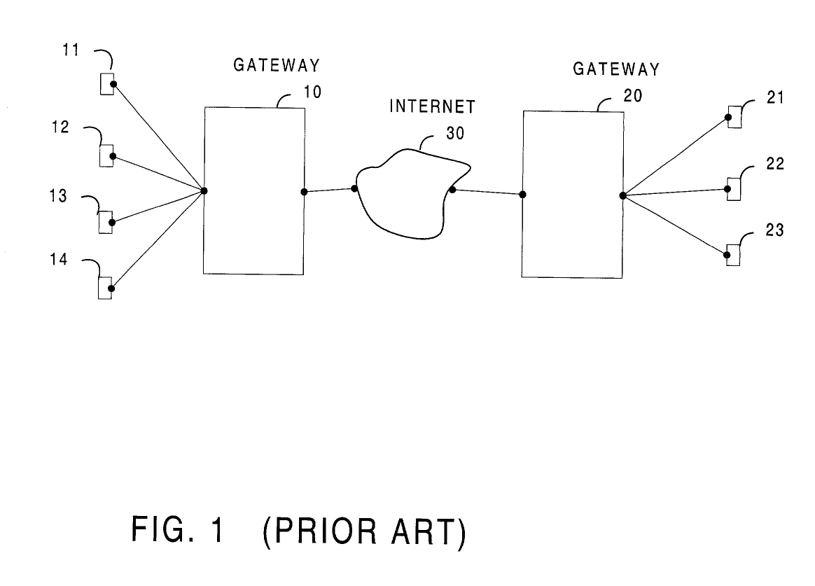

FIG. 2 is a flowchart showing one embodiment of selectively compressing data packets.

FIG. 3 is a flowchart showing an embodiment for determining whether to bypass compression.

### DETAILED DESCRIPTION

Selectively compressing data to avoid trying to compress data packets that are already compressed saves valuable cycles. Searching for a predetermined marker in the data packet is often less expensive in terms of time and resources than the compression process.

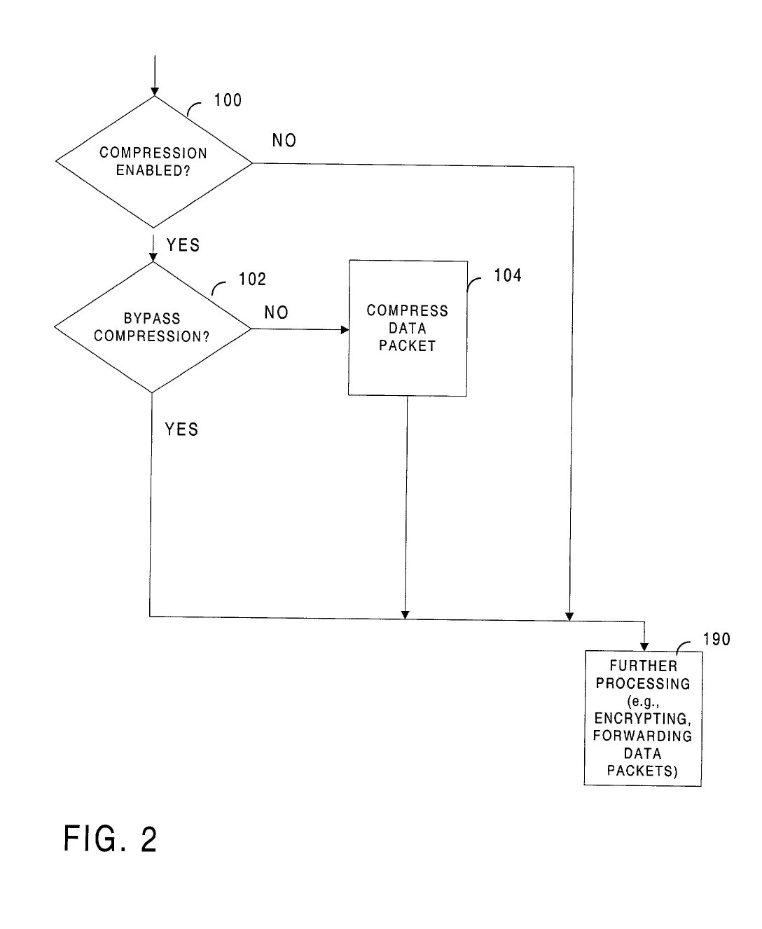

FIG. 2 is a flowchart showing one embodiment of selectively compressing a data packet. First, a determination is made whether compression is enabled (box 100). As previously described in the background section, whether compression is enabled is often decided in an Internet Key Exchange (“IKE”) process. If compression is enabled then execution continues at box 102. If compression is not enabled, then execution continues at box 190.

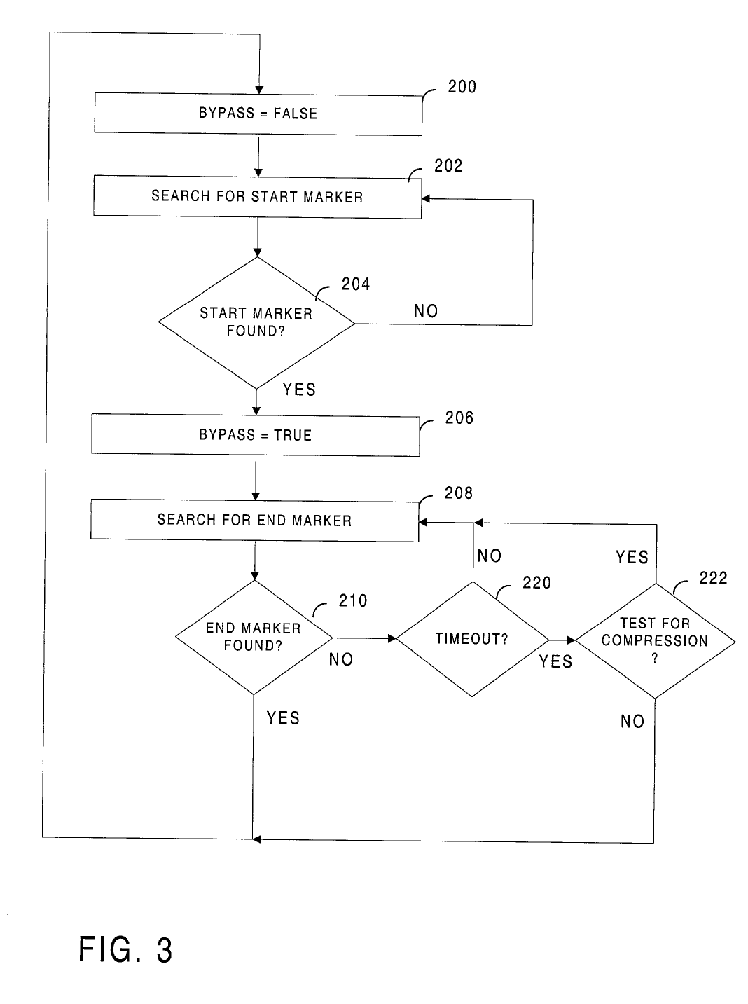

At box 102, a determination is made whether to bypass the compression process, as will be described in detail with respect to FIG. 3. If the determination is that the compression process is bypassed then execution continues to block 190. If there is no bypass, execution proceeds from block 102 to block 104, at which the data packet is compressed. After compression, execution proceeds from block 104 to block 190.

At block 190, further processing of the packet data is performed. In one embodiment, the data packet is encrypted and then forwarded over a network.

FIG. 3 is a flowchart showing an embodiment for determining whether to bypass compression. As each data packet is processed, the flowchart progresses similar to a state diagram, and a variable BYPASS indicates whether to bypass the compression or not. The flowchart starts at block 200, at which BYPASS is initialized to FALSE. Any data packet forwarded while BYPASS is FALSE will go through the compression process. The flowchart continues at block 202 at which the data packets are searched for a start marker that indicates that compressed data follows.

As one example, a GIF image, which is a compressed image, includes in a header the text string “GIF”. A search for this string can be performed on each of the data packets. In one embodiment, a search string engine of a network processor can be used to search the data packets. These search string engines can quickly detect the presence of such a string. Other types of compressed data have other markers which indicate the beginning of the compressed data, whether it be compressed audio, video, graphic or other types of data.

At block 204, if the start marker is not found then the search for the start marker continues (back to block 202). Once the start marker is found, execution proceeds at block 206, at which BYPASS is set to TRUE. Any data packets processed while BYPASS is TRUE will bypass the compression process.

At block 208, data packets are searched for an end marker that indicates the end of compressed data. As an example, the end of a GIF image is signified by an end marker of a string having two consecutive bytes of “0” followed by“;” at the end of a data packet. If the end marker is not detected at block 210, then control proceeds to block 220 at which a timeout decision is made. The timeout allows for the bypass to be suspended if the end marker has not been found within a certain limit, such as within a particular number of data packets, bytes, or time limit. At block 220, if there is no timeout, then the search for the end marker continues at block 208.

However, if there is a timeout, e.g., due to the end marker not being found within 4K bytes, then the timeout is reset and control proceeds to block 222. At block 222, a test is performed to determine whether the current data packet being processed is compressed. One way to detect compression is to try to compress the data block. If the compression fails, i.e., results in a larger packet size, then the data packet is already compressed. If the test shows that the current data packet being processed is compressed, then control proceeds to block 208 to continue searching for the end marker. However, if the test shows that the current data packet being processed is not compressed, then somehow the end marker was missed. Process control proceeds from block 222 back to block 200. Similarly, at block 210, when the end marker is found, then process control continues at block 200, and the process starts over.

In one embodiment, the search for start markers (block 202) and end markers (block 208) is performed on only portions of each data packet. As one example, certain headers, such as the IP-header and TCP-header, are excluded from the search.

In one embodiment, both the start marker and the end marker may be in the same data packet. In this case, that data packet bypasses the compression process, and compression resumes until another start marker is found.

Of course, the described embodiment can easily be expanded to accommodate more than one type of start and end marker. For example, there are many different types of compressed data, and a search can be made for multiple start markers. Once one of the start markers is found, then the appropriate type of end marker can be searched for. Overlapping types of start and end markers can also be accommodated.

In one embodiment, software for programming a computer to operate as described can be provided as instructions stored on floppy disk, CD-ROM, or other storage media. Alternatively, the software can be downloaded via the Internet or a wireless network. The software is then installed to a storage medium on the host system, such as a hard disk, random access memory, or non-volatile memory.

Thus, a method for selectively compressing data packets is disclosed. The specific arrangements and methods described herein are merely illustrative. Numerous modifications in form and detail may be made without departing from the scope of the invention as claimed below. The invention is limited only by the scope of the appended claims.

What is claimed is:

1. A method of selectively compressing data packets comprising:
bypassing a compression process responsive to detecting a first marker in the data packets; and
resuming the compression process responsive to detecting a second marker in the data packets.

2. The method of claim 1 wherein the first marker indicates that data subsequent to the first marker is compressed.

3. The method of claim 2 wherein the second marker indicates that data previous to the second marker is compressed.

4. The method of claim 3 wherein the first marker is a predetermined string of data.

5. The method of claim 4 wherein the first marker is a predetermined text string of data.

6. The method of claim 5 wherein the compression process compresses the data packets prior to sending the data packets over a network.

7. The method of claim 6 further comprising:
encrypting the data packets prior to sending the data packets over the network.

8. The method of claim 6 further comprising:
resuming the compression process after a timeout occurs.

9. A method of processing data packets comprising:
searching a first data packet for a first marker that indicates that subsequent data is already compressed;
forwarding the first data packet without trying to re-compress it, if the first marker was found; and
compressing and forwarding the first data packet, if the first marker was not found.

10. The method of claim 9, wherein searching the first data packet for the first marker is performed by looking for a predetermined text string in the first data packet.

11. The method of claim 9 further comprising:
forwarding one or more subsequent data packets without trying to recompress them, if the first marker was found; and
compressing and forwarding the one or more subsequent data packets, if the first marker was not found.

12. The method of claim 11, further comprising:
searching for a second marker that indicates that data following the second marker is not compressed; and
compressing and forwarding a second set of one or more subsequent data packets after finding the second marker, wherein each of the second set of one or more subsequent data packets are searched for the first marker.

13. The method of claim 12, wherein searching for the second marker is performed by looking for a second predetermined text string.

14. A method of selectively compressing data packets comprising:
searching a data packet for a first string of data;
bypassing a compression process responsive to detecting the first string of data;
searching for a second string of data; and
resuming the compression process responsive to detecting the second string of data.

15. The method of claim 14, wherein a string search engine is used to search the data packet for the first string of data.

16. The method of claim 14, wherein a string search engine of a network processor is used to search the data packet for the first string of data.

17. The method of claim 14 further comprising:
searching a subsequent data packet for a third string of data;
bypassing the compression process responsive to detecting the third string of data;
searching for a fourth string of data; and
resuming the compression process responsive to detecting the fourth string of data.

18. The method of claim 14 further comprising:
resuming the compression process responsive to a timeout event.

19. The method of claim 14 further comprising:
testing whether a current data packet is compressed responsive to a timeout event.

20. An article comprising a computer-accessible medium which stores computer-executable instructions, the instructions causing a computer to:
search a data packet for a first string of data;
bypass a compression process responsive to detecting the first string of data;
search for a second string of data; and
resume the compression process responsive to detecting the second string of data.

21. The article of claim 20, the article further comprises instructions to:
search a subsequent data packet for a third string of data;
bypass the compression process responsive to detecting the third string of data;
search for a fourth string of data; and
resume the compression process responsive to detecting the fourth string of data.

22. The article of claim 20, wherein the compression process compresses data packets prior to the data packets being forwarded across a network.

23. The article of claim 22, wherein the data packets are encrypted before being forwarded across the network.
